(19) United States
(12) Patent Application Publication
(10) Pub. No.: US 2022/0049123 A1
(43) Pub. Date: Feb. 17, 2022

(54) TOPCOAT COMPOSITION OF IMAGING BLANKET FOR REDUCING COATING DEFECTS

(71) Applicant: XEROX CORPORATION, NORWALK, CT (US)

(72) Inventors: Kenny-Tuan T. Dinh, Webster, NY (US); Kyle B. Tallman, Perry, NY (US); Lin Ma, Pittsford, NY (US); Alexander N. Klymachyov, Webster, NY (US); Angela Schnuerch, Naples, NY (US); Michael L. Mehan, Pittsford, NY (US); Eric Robert Dudek, Webster, NY (US); Lanhui Zhang, Webster, NY (US); Varun Sambhy, Pittsford, NY (US); Michael S. Roetker, Webster, NY (US); Santokh S. Badesha, Pittsford, NY (US)

(73) Assignee: XEROX CORPORATION, NORWALK, CT (US)

(21) Appl. No.: 16/991,251

(22) Filed: Aug. 12, 2020

(51) Int. Cl. C09D 183/08; B41N 10/04; B41F 7/20

(52) U.S. Cl. CPC C09D 183/08; C08K 3/36; B41F 7/20; B41N 10/04

(57) ABSTRACT

Provided herein is a topcoat composition comprising at least one fluorosilicone, at least one infrared-absorbing filler, and silicone dioxide present in an amount ranging from greater than about 5% to about 10%, by weight based on a total weight of the topcoat composition, wherein when the topcoat composition has a shear rate between about 2 s⁻¹ to about 3 s⁻¹, the topcoat composition has a viscosity ranging from about 1500 mPa/s to about 500 mPa/s and the shear rate does not decrease as the viscosity increases or decreases. Further provided herein are methods of making the topcoat composition, as well as an imaging blanket and methods of reducing coating defects on a media coated using the imaging member.

### DETAILED DESCRIPTION

### Field of the Disclosure

This disclosure relates generally to marking and printing systems, and more specifically to a topcoat composition for an imaging blanket of such a system.

### Background

Typical lithographic and offset printing techniques use plates that are permanently patterned and are therefore useful only when printing a large number of copies of the same image (i.e., long print runs), such as magazines, newspapers, and the like. However, they do not permit creating and printing a new pattern from one page to the next without removing and replacing the print cylinder and/or the imaging plate (i.e., the technique cannot accommodate true high speed variable data printing wherein the image changes from impression to impression, for example, as in the case of digital printing systems). Furthermore, the cost of the permanently patterned imaging plates or cylinders is amortized over the number of copies. The cost per printed copy is therefore higher for shorter print runs of the same image than for longer print runs of the same image, as opposed to prints from digital printing systems.

Accordingly, a lithographic technique, referred to as variable data lithography, has been developed that uses an imaging member comprising a non-patterned reimageable surface or imaging blanket that is initially uniformly coated with a dampening fluid layer. Regions of the dampening fluid are removed by exposure to a focused radiation source (e.g., a laser light source) to form pockets. A temporary pattern in the dampening fluid is thereby formed over the non-patterned imaging blanket. Ink applied thereover is retained in the pockets formed by the removal of the dampening fluid. The inked surface is then brought into contact with a print substrate, and the ink transfers from the pockets in the dampening fluid layer to the print substrate. The dampening fluid may then be removed, a new uniform layer of dampening fluid applied to the imaging blanket, and the process repeated.

The imaging blanket comprises a low surface energy top coat, for example a dispersion comprising fluorosilicone and infrared-absorbing fillers such as carbon black. This dispersion is typically applied as a wet film onto an engineered rubber substrate known as a “carcass” and then cured at a high temperature, such as at about 160° C. for about 4 hours, to yield the final imaging blanket with a topcoat. Current topcoat compositions comprising carbon black and fluorosilicone, however, may exhibit certain printing defects on seamless carcasses or may develop such defects over time and/or with use. For example, mechanical stresses due to repeated contact of the imaging member with the printed surfaces may result in wearing off of the fluorosilicone coating, which may then create high surface energy point defects, causing background imaging defects and shorter imaging life. For example, known coating defects may include ring coating defects and tree-bark coating defects (i.e., print quality defects that result in an image having an uneven, tree bark-like appearance). Coating conditions such as humidity, temperature and coating speed, as well as adaptations to the solvents used, percent solids, and carbon black loading in the topcoat composition have not heretofore been effective to eliminate coating defects.

There is thus a need in the art for imaging blankets having improved topcoats, such that print image coating defects attributable to the topcoats are reduced or eliminated.

### SUMMARY

Disclosed herein is a topcoat composition for an imaging blanket that comprises an infrared-absorbing filler, such as carbon black, a fluorosilicone elastomer, and silicon dioxide present in an amount ranging from greater than about 5% to about 10%, such as from about 6% to about 7% or about 6.5% to about 6.7%, based on a total weight of the topcoat composition. In certain embodiments, when the topcoat composition has a shear rate between about 2 s⁻¹ to about 3 s⁻¹, the topcoat composition has a viscosity ranging from about 1500 mPa/s to about 500 mPa/s and the shear rate does not decrease as the viscosity increases or decreases. In certain embodiments the at least one infrared-absorbing filler is carbon black, and in certain embodiments, the at least one infrared-absorbing filler is present in the topcoat composition in an amount ranging from about 5% to about 35% by weight, based on the total weight of the topcoat composition.

According to various embodiments of the disclosure, the at least one fluorosilicone is chosen from vinyl-terminated trifluoropropyl methylsiloxane polymers, and in certain embodiments, the at least one fluorosilicone is present in the topcoat composition in an amount ranging from about 40% to about 80% by weight, based on the total weight of the topcoat composition.

In certain embodiments, the topcoat composition disclosed herein further comprises at least one dispersant, such as a polyoxyalkylene amine derivative, and according to certain embodiments, the topcoat composition further comprises as least one crosslinking agent, such as a methyl hydrosiloxane-trifluoropropylmethyl siloxane. According to various embodiments of the disclosure, the topcoat composition further comprises at least one catalyst, such as a platinum catalyst.

Further disclosed herein is an imaging blanket for variable data lithography comprising (i) a substrate and (ii) a topcoat composition disposed on the substrate that comprises at least one fluorosilicone, at least one infrared-absorbing filler such as carbon black, and silicon dioxide present in an amount ranging from greater than about 5% to about 10%, based on a total weight of the topcoat composition, wherein when the topcoat composition has a shear rate between about 2 s⁻¹ to about 3 s⁻¹, the topcoat composition has a viscosity ranging from about 1500 mPa/s to about 500 mPa/s and the shear rate does not decrease as the viscosity increases or decreases.

In certain embodiments, the substrate comprises at least one material selected from the group consisting of metals, polyimides, plastic composites, and woven fabrics. In certain embodiments, the topcoat composition is cured to the substrate at a temperature ranging from about 135° C. to about 165° C. for a time period ranging from about 15 minutes to about 5 hours. According to various aspects disclosed herein, the topcoat composition has a thickness ranging from about 0.5 μm to about 4 mm, and according to certain aspects of the disclosure, the topcoat composition has a mean roughness Rₐ ranging from about 0.2 μm to about 1.0 μm.

In various embodiments of the disclosure, the topcoat composition has a tangent of delta (tan δ) at 25° C. ranging from about 0.08 to about 0.20 as measured by dynamic mechanical analysis. In certain aspects, the topcoat composition has a degree of crosslinking ranging from about 45% to about 55%.

Also provided herein are methods of making a topcoat composition for a variable data lithography imaging blanket comprising mixing in a solvent a dispersant, beads, an infrared-absorbing filler, silicon dioxide in an amount ranging from greater than about 5% to about 10% by weight based on a total weight of the topcoat composition, an inhibitor, a fluorosilicone, and a crosslinking agent to create a mixture; rolling the mixture; filtering the mixture to remove the beads; adding a catalyst to the mixture; and filtering the dispersant to create a topcoat composition.

Also disclosed herein are methods of reducing coating defects on a media coated using an imaging member for variable data lithography comprising applying a fountain solution to an imaging member comprising a cured topcoat composition; forming a latent image by evaporating the fountain solution from selective locations on the cured topcoat composition to form hydrophobic non-image areas and hydrophilic image areas; developing the latent image by applying an ink composition to the hydrophilic image areas; and transferring the developed latent image to a receiving substrate, wherein the topcoat composition comprises at least one fluorosilicone, at least one infrared-absorbing filler, and silicon dioxide present in an amount ranging from greater than about 5% to about 10%, based on a total weight of the topcoat composition, and wherein before curing, when the topcoat composition has a shear rate between about 2 s⁻¹ to about 3 s⁻¹, the topcoat composition has a viscosity ranging from about 1500 mPa/s to about 500 mPa/s and the shear rate does not decrease as the viscosity increases or decreases.

### BRIEF DESCRIPTION OF THE DRAWINGS

The accompanying drawings, which are incorporated in and constitute a part of this specification, illustrate embodiments of the present teachings and together with the description, serve to explain the principles of the present teachings.

FIG. 1 is a side-view of a variable data lithography system according to various embodiments disclosed herein.

FIG. 2 is a graph showing the shear rate (1/s) as a function of viscosity (mPa s) for four topcoat compositions as described in Example 1, comprising a 1% SiO₂ dispersion, a 3% SiO₂ dispersion, a 6.5% SiO₂ dispersion, and a 10% SiO₂ dispersion.

FIG. 3 is a plot showing a visual subjective image rating assigned for tree bark coating defect observed for (1) a control sample topcoat composition comprising a 1% SiO₂ dispersion coated using a drawbar coating method, (2) six sample topcoat compositions comprising a 1% SiO₂ dispersion; and (3) seven sample topcoat compositions comprising a 6.5% SiO₂ dispersion, as described in Example 1.

It should be noted that some details of the figures may have been simplified and are shown to facilitate understanding of the embodiments rather than to maintain strict structural accuracy, detail, and scale.

### DESCRIPTION OF THE EMBODIMENTS

Reference will now be made in detail to embodiments of the present disclosure. The following description is merely exemplary.

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings, and it is to be understood that other embodiments may be utilized and that changes may be made without departing from the scope of the present teachings. The following description is, therefore, merely illustrative.

Although embodiments of the disclosure herein are not limited in this regard, the terms “plurality” and “a plurality” as used herein may include, for example, “multiple” or “two or more.” The terms “plurality” or “a plurality” may be used throughout the specification to describe two or more components, devices, elements, units, parameters, or the like. For example, “a plurality of resistors” may include two or more resistors.

As used herein, the term “polyorganosiloxane” is used interchangeably with “siloxane,” “silicone,” “silicone oil,” and “silicone rubber.” Polyorganosiloxanes are well-understood to those of skill in the relevant art to refer to siloxanes having a backbone formed from silicon and oxygen atoms and sidechains containing carbon and hydrogen atoms. As used herein, the term “silicone” should also be understood to exclude siloxanes that contain fluorine atoms, while the term “fluorosilicone” is used to cover the class of siloxanes that contain fluorine atoms. Other atoms may be present in the silicone, for example, nitrogen atoms in amine groups which are used to link siloxane chains together during crosslinking.

The term “fluorosilicone” as used herein refers to polyorganosiloxanes having a backbone formed from silicon and oxygen atoms, and sidechains containing carbon, hydrogen, and fluorine atoms. At least one fluorine atom is present in the sidechain. The sidechains can be linear, branched, cyclic, or aromatic. The fluorosilicone may also contain functional groups, such as amino groups, which permit additional cross-linking. When the cross-linking is complete, such groups become part of the backbone of the overall fluorosilicone. The side chains of the polyorganosiloxane can also be alkyl or aryl. Fluorosilicones are commercially available, for example CF1-3510 from NuSil® or SLM (n-27) from Wacker.

The terms “media substrate,” “print substrate,” and “print media” generally refer to a usually flexible physical sheet of paper, polymer, Mylar® material, plastic, or other suitable physical print media substrate, sheets, webs, etc., for images, whether precut or web fed.

The term “printing device” or “printing system” as used herein refers to a digital copier or printer, scanner, image printing machine, xerographic device, electrostatographic device, digital production press, document processing system, image reproduction machine, bookmaking machine, facsimile machine, multi-function machine, or generally an apparatus useful in performing a print process or the like and can include several marking engines, feed mechanism, scanning assembly as well as other print media processing units, such as paper feeders, finishers, and the like. A “printing system” may handle sheets, webs, substrates, and the like. A printing system can place marks on any surface, and is any machine that reads marks on input sheets, or any combination of such machines.

As used herein, the term “ink-based digital printing” is used interchangeably with “variable data lithography printing” and “digital offset printing,” and refers to lithographic printing of variable image data for producing images on a substrate that are changeable with each subsequent rendering of an image on the substrate in an image forming process. As used herein, “ink-based digital printing” includes offset printing of ink images using lithographic ink where the images are based on digital image data that may vary from image to image. As used herein, the ink-based digital printing may use a “digital architecture for lithographic ink” (DALI) or a variable data lithography printing system or a digital offset printing system, where the system is configured for lithographic printing using lithographic inks and based on digital image data, which may vary from one image to the next. As used herein, an ink-based digital printing system using DALI may be referred to as a DALI printer. As used herein, an imaging member of a DALI printer may be referred to interchangeably as a DALI printing plate and a DALI imaging blanket.

All physical properties that are defined hereinafter are measured at 20° C. to 25° C. unless otherwise specified. The term “room temperature” refers to a temperature ranging from about 20° C. to about 25° C., such as about 22° C., unless otherwise specified.

Many of the examples mentioned herein are directed to an imaging blanket (including, for example, a printing sleeve, belt, imaging blanket employed on a drum, and the like) that has a uniformly grained and textured blanket surface that is ink-patterned for printing. Further examples of variable data lithographic printing are disclosed in U.S. Patent Application Publication No. 2012/0103212 A1 (the '212 publication) published May 3, 2012, and based on U.S. patent application Ser. No. 13/095,714, which is commonly assigned, and the disclosure of which is hereby incorporated by reference herein in its entirety.

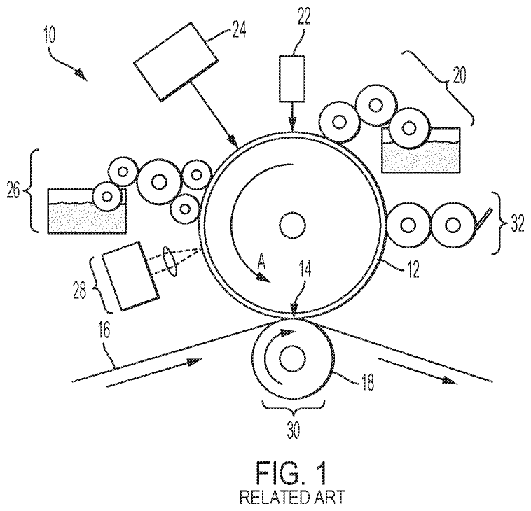

FIG. 1 depicts an exemplary variable data lithography printing system 10. A general description of the exemplary system 10 shown in FIG. 1 is provided here. Additional details regarding individual components and/or subsystems shown in the exemplary system 10 of FIG. 1 may be found in the '212 publication. As shown in FIG. 1, the exemplary system 10 may include an imaging member 12 used to apply an inked image to a target image receiving media substrate 16 at a transfer nip 14. The transfer nip 14 is produced by an impression roller 18, as part of an image transfer mechanism 30, exerting pressure in the direction of the imaging member 12.

The imaging member 12 may include a reimageable surface layer (imaging blanket layer or carcass) formed over a structural mounting layer that may be, for example, a cylindrical core, or one or more structural layers over a cylindrical core. A fountain solution subsystem 20 may be provided generally comprising a series of rollers, which may be considered as dampening rollers or a dampening unit, for uniformly wetting the reimageable surface with a layer of dampening fluid or fountain solution, generally having a uniform thickness, to the reimageable surface of the imaging member 12. Once the dampening fluid or fountain solution is metered onto the reimageable surface, a thickness of the layer of dampening fluid or fountain solution may be measured using a sensor 22 that provides feedback to control the metering of the dampening fluid or fountain solution onto the reimageable surface.

An optical patterning subsystem 24 may be used to selectively form a latent image in the uniform fountain solution layer by image-wise patterning the fountain solution layer using, for example, laser energy. It is advantageous to form the reimageable surface of the imaging member 12 from materials that should ideally absorb most of the infrared or laser energy emitted from the optical patterning subsystem 24 close to the reimageable surface. Forming the surface of such materials may advantageously aid in substantially minimizing energy wasted in heating the fountain solution and coincidentally minimizing lateral spreading of heat in order to maintain a high spatial resolution capability. Briefly, the application of optical patterning energy from the optical patterning subsystem 24 results in selective evaporation of portions of the uniform layer of fountain solution in a manner that produces a latent image.

The patterned layer of fountain solution having a latent image over the reimageable surface of the imaging member 12 is then presented or introduced to an inker subsystem 26. The inker subsystem 26 is usable to apply a uniform layer of ink over the patterned layer of fountain solution and the reimageable surface of the imaging member 12. In embodiments, the inker subsystem 26 may use an anilox roller to meter an ink onto one or more ink forming rollers that are in contact with the reimageable surface of the imaging member 12. In other embodiments, the inker subsystem 26 may include other traditional elements such as a series of metering rollers to provide a precise feed rate of ink to the reimageable surface. Ink from the inker subsystem 26 may adhere to the areas of the reimageable surface that do not have fountain solution thereon to form an ink image, while ink deposited on the areas of the reimageable surface on which the fountain solution layer remains will not adhere to the reimageable surface.

Cohesiveness and viscosity of the ink residing on the reimageable plate surface may be modified by a number of mechanisms, including through the use of some manner of rheology control subsystem 28. In embodiments, the rheology control subsystem 28 may form a partial cross-linking core of the ink on the reimageable plate surface to, for example, increase ink cohesive strength relative to an adhesive strength of the ink to the reimageable plate surface. In embodiments, certain curing mechanisms may be employed. These curing mechanisms may include, for example, optical or photo curing, heat curing, drying, or various forms of chemical curing. Cooling may be used to modify rheology of the transferred ink as well via multiple physical, mechanical or chemical cooling mechanisms.

Substrate marking occurs as the ink is transferred from the reimageable surface of imaging member 12 to media substrate 16 using the transfer subsystem 30. With the adhesion and/or cohesion of the ink having been modified by the rheology control system 28, modified adhesion and/or cohesion of the ink causes the ink to transfer substantially completely, preferentially adhering to the media substrate 16 as it separates from the reimageable surface of the imaging member 12 at the transfer nip 14. Careful control of the temperature and pressure conditions at the transfer nip 14, among other things, may allow transfer efficiencies for the ink from the reimageable plate surface of the imaging member 12 to the media substrate 16 to exceed, for example, 95%. While it is possible that some fountain solution may also wet substrate 16, the volume of such transferred fountain solution will generally be minimal so as to rapidly evaporate or otherwise be absorbed by the substrate 16.

Finally, a cleaning system 32 is provided to remove residual products, including non-transferred residual ink and/or remaining fountain solution from the reimageable surface in a manner that is intended to prepare and condition the reimageable surface of the imaging member 12 to repeat the above cycle for image transfer. An air knife may be employed to remove residual fountain solution. It is anticipated, however, that some amount of ink residue may remain. Removal of such remaining ink residue may be accomplished by cleaning subsystem 32. The cleaning subsystem 32 may include, for example, at least a first cleaning member, such as a sticky or tacky member, in physical contact with the reimageable surface of the imaging member 12, where the sticky or tacky member removes residual ink and any remaining small amounts of surfactant compounds from the fountain solution of the reimageable surface of the imaging member 12. The sticky or tacky member may then be brought into contact with a smooth roller to which residual ink may be transferred from the sticky or tacky member, the ink being subsequently stripped from the smooth roller by, for example, a doctor blade. Any other suitable cleaning system can be employed.

Regardless of the type of cleaning system used, cleaning of the residual ink and fountain solution from the reimageable surface of the imaging member 12 can prevent or reduce the risk of a residual image from being printed in the proposed system. Once cleaned, the reimageable surface of the imaging member 12 is again presented to the fountain solution subsystem 20 by which a fresh layer of fountain solution is supplied to the reimageable surface of the imaging member 12, and the process is repeated.

As the process is repeated, natural wear of the imaging member blanket may occur, causing the ink transferred to the media substrate 16 to exhibit coating defects such as ring coating defects and tree-bark coating defects. Disclosed herein is a topcoat composition for use on an imaging blanket comprising at least one fluorosilicone, at least one infrared-absorbing filler, such as carbon black, and silicon dioxide present in an amount ranging from greater than about 5% to about 10%, by weight based on the total weight of the composition. The topcoat composition disclosed herein may provide a media substrate with enhanced print quality, including reduced coating defects, such as a reduced tree-bark effect, without affecting surface roughness, topcoat deformation as measured by the viscoelastic properties of the topcoat composition, image quality, or the degree of fluorosilicone crosslinking, as compared to a topcoat composition comprising, for example, less than 5% SiO₂, such as about 1% SiO₂.

The topcoat composition disclosed herein comprises silicon dioxide (also referred to herein as silica or SiO₂) in an amount ranging from greater than about 5% to about 10%, based on the total weight of the topcoat composition. Silica can help increase the tensile strength of the topcoat composition and increase wear resistance. Silica may be present in an amount ranging from greater than about 5% to about 10% by weight based on the total weight of the topcoat composition, such as from about 5.5% to about 8%, from about 6% to about 7%, from about 6.5% to about 6.7%, or about 6.5%. The silica may have an average particle size ranging from about 10 nm to about 0.2 μm, such as from about 50 nm to about 0.1 μm or about 20 nm.

In certain embodiments, the topcoat composition disclosed herein may exhibit unexpectedly superior properties over similar topcoat compositions comprising, for example silicon dioxide present in an amount ranging from about 5% or less, such as from about 3% to about 1% or about 1.05% or about 1.15%. For example, the topcoat compositions disclosed herein may exhibit reduced coating defects over time and/or with use and therefore may result in an imaging blanket that is longer-lasting than an imaging blanket comprising a topcoat composition that comprises silicon dioxide present in an amount ranging from about 5% or less. While not wishing to be bound by theory, it is believed that the coating defects observed with imaging blankets having a topcoat composition that comprises silicon dioxide present in an amount ranging from about 5% or less may be a result of the viscosity changes that occur in the topcoat formulation as a result of increasing shear rate. It has been observed that, when shear rate is measured as a function of viscosity, topcoat compositions having less than about 5% silicon dioxide exhibit an S-shaped transition curve when the shear rate is the range of about 2 to about 3 s⁻¹, such that there is a negative slope between the high and low viscosity transition. Unexpectedly, when the topcoat composition comprises greater than about 5% silicon dioxide, the S-shaped transition is pushed out of the 2 to about 3 s⁻¹ range of shear rate or disappears entirely. Accordingly, in certain aspects of the disclosure, when the topcoat compositions disclosed herein have a shear rate between about 2 s⁻¹ to about 3 s⁻¹, the topcoat composition has a viscosity ranging from about 1500 mPa/s to about 500 mPa/s and the shear rate does not decrease as the viscosity increases or decreases, i.e., the S-shaped curve is pushed out the 2 to about 3 s⁻¹ range or eliminated.

In addition to silicon dioxide, the topcoat compositions disclosed herein further comprise at least one fluorosilicone. As used herein, fluorosilicone refer to polyorganosiloxanes having a backbone formed from silicon and oxygen atoms and sidechains containing carbon, hydrogen, and fluorine atoms. The sidechains can be linear, branched, cyclic, or aromatic, and the fluorosilicone may also contain functional groups, such as amino groups, that permit additional crosslinking. When the crosslinking is complete, such groups become part of the backbone of the overall fluorosilicone.

In certain embodiments of the fluorosilicones disclosed herein, at least 75% of the siloxane units are fluorinated. The percentage of fluorinated siloxane units can be determined by considering that each silicon atom contains two possible sidechains. The percentage is calculated as the number of sidechains having at least one fluorine atoms divided by the total number of sidechains (i.e., twice the number of silicon atoms). In certain embodiments, the fluorosilicone is a vinyl-functional fluorosilicone, such as a vinyl-terminated trifluoropropyl methylsiloxane polymer (e.g., SML 50330 available from Wacker). In certain embodiments, the at least one fluorosilicone may be present in the topcoat composition in an amount ranging from about 20% to about 80%, such as from about 40% to about 70% or from about 55% to about 65%, by weight based on the total weight of the topcoat composition.

In certain embodiments, the topcoat compositions disclosed herein further comprise at least one infrared-absorbing filler. The at least one infrared-absorbing filler is able to absorb energy from the infra-red portion of the spectrum (having a wavelength of from about 750 nm to about 1000 nm). This may aid in efficient evaporation of a fountain solution. In certain embodiments, the at least one infrared-absorbing filler may be chosen from carbon black, a metal oxide such as iron oxide, carbon nanotubes, graphene, graphite, or carbon fibers. The at least one infrared-absorbing filler may have an average particle size of from about 2 nanometers to about 10 microns, such as from about 20 nanometers to about 5 microns or from about 100 nanometers to about 1 micron.

In certain embodiments, a heat-treated carbon black may be used. In this regard, carbon black powders are known to contain sulfur in trace quantities that may be difficult to detect, even in “low-sulfur” grades of carbon black. Sulfur is known to be a platinum catalyst poison and may inhibit platinum from acting as a catalyst. Carbon black may be heat treated prior to use. Without being bound by theory, it is believed that the heat treatment may reduce any free sulfur content in the carbon black, and thus enhance curing of the topcoat composition by reducing platinum catalyst poisoning. Therefore, according to certain embodiments of the disclosure, the infrared-absorbing filler is a low-sulfur carbon black, for example a carbon black having a sulfur content of about 0.3% or less, such as about 0.15% or less.

In this regard, sulfur has a boiling point of about 445° C. Thus, the carbon black should be heated above this temperature to fully extract any sulfur present in the carbon black. In certain embodiments, the carbon black is heat treated to a temperature of at least about 445° C., such as at least about 550° C. or at least about 600° C. In certain embodiments, the carbon black is heat treated for a time period ranging from about 30 minutes to about 2 hours.

In certain embodiments, the at least one infrared-absorbing filler may be present in the topcoat composition in an amount ranging from about 5% to about 35%, such as from about 5% to about 20%, from about 5% to about 10%, from about 7% to about 17% or from about 10% to about 15%, by weight based on the total weight of the topcoat composition.

In certain embodiments, the topcoat composition disclosed herein further comprises additional components, such as, for example, a crosslinking agent, a catalyst, a solvent such as an alkyl-acetate solvent (e.g., butyl acetate), a dispersant, and/or an inhibitor. In certain embodiments, the solvent in the topcoat composition may be an environmentally-friendly organic solvent, such as butyl acetate.

In certain embodiments, the topcoat composition may further comprise a crosslinking agent. The crosslinking agent may be chosen from any crosslinking agent known in the art, and may, for example, be a methylhydrosiloxane-trifluoropropylmethylsiloxane, such as an XL-150 crosslinker commercially available from NuSil, or a methyl hydrosiloxane-trifluoropropylmethyl siloxane, such as SLM 50336 commercially available from Wacker. In certain embodiments, the crosslinking agent may be present in the topcoat composition in an amount ranging from about 10% to about 28%, such as from about 12% to about 20% or about 15%, by weight based on the total weight of the topcoat composition. The fluorosilicone may be combined with the crosslinking agent to form a crosslinked fluorosilicone elastomer, wherein the infrared-absorbing filler and the silica are dispersed throughout the crosslinked fluorosilicone. In certain instances, the crosslinked fluorosilicone can be formed by a platinum-catalyzed crosslinking reaction between a vinyl-functional silicone and at least one of a hydride-functional silicone or a hydride-functional fluorosilicone. The infrared-absorbing filler and the silica may be dispersed throughout the vinyl-functional fluorosilicone before the crosslinking reaction.

In certain embodiments, the topcoat composition may further comprise a catalyst, such as a platinum catalyst, for example a 14.3% Platinum in butyl acetate. In one embodiment, the topcoat composition comprises between about 0.15% and about 0.35%, such as between about 0.2% and about 0.3% or about 0.25%, by weight of a catalyst based on the total weight of the topcoat composition.

In certain embodiments, the topcoat composition may further comprise at least one dispersant. The dispersant may be chosen from any dispersant recognized in the art, such as, for example, a polyoxyalkylene amine derivative (e.g., Zephrym® PD 7000 available from Croda International Plc). The dispersant may be added to the topcoat composition in an amount ranging from about 0.1% to about 5%, such as from about 0.5% to about 2.5% or from about 1% to about 2%, by weight based on the total weight of the topcoat composition. In certain embodiments, the ratio of the at least one infrared-absorbing filler to the dispersant may range from about 5:1 to about 20:1, such as from about 10:1 to about 18:1. A dispersant may ensure that the infrared-absorbing filler and the silica are sufficiently dispersed throughout the fluorosilicone matrix.

In certain embodiments, the topcoat composition may further comprise at least one polymerization inhibitor. The at least one polymerization inhibitor may be chosen from any inhibitor known in the art, such as the inhibitor PT 88. In certain embodiments, the at least one polymerization inhibitor may be present in the topcoat composition in an amount ranging from about 0.1% to about 5%, such as from about 0.5% to about 1%, by weight based on the total weight of the topcoat composition.

In certain embodiments, the topcoat compositions disclosed herein may be made by combining a first ingredient with a solvent and beads, rolling, combining a second ingredient, rolling, combining a third ingredient, rolling, etc. For example, in certain embodiments, a dispersant may be combined with a solvent and steel beads and rolled; next, an infrared-absorbing filler is combined with the dispersant mixture and rolled, and then silica is combined with the dispersant and infrared-absorbing filler and rolled. Next, an inhibitor is added to the mixture, rolled, and then a flourosilicone is added and rolled. Finally, a crosslinking agent is added to the mixture and rolled. After rolling, the mixture may be filtered to remove the beads, and a catalyst, such as an acid catalyst, may be added. The catalyzed mixture may then be filtered and de-gassed before application to an imaging blanket as a topcoat. In certain embodiments, the ratio of Si—H to vinyl groups in the topcoat composition ranges from about 1 to about 2, such as 1.12.

Further disclosed herein is a method of making an imaging blanket having an improved topcoat. In certain embodiments, the method comprises coating the topcoat composition disclosed herein on a substrate and curing the topcoat composition to form the improved imaging blanket. The substrates disclosed herein can be rolls, belts, or plates mounted to rolls, as is well-known in the art. The substrate can be made of any suitable material, such as, for example, polymers such as polyimide; silicone or biaxially-oriented polyethylene terephthalate (e.g., Mylar®); metals such as nickel, aluminum, or aluminum alloys; woven fabric; quartz; plastic composites; or combinations thereof. The topcoat composition disclosed herein may be coated on the substrate by any method known in the art, such as by flow coating, dip-coating, draw bar coating, or ribbon flow coating.

When coated on the imaging blanket, the topcoat composition disclosed herein may have a thickness ranging from about 0.5 μm to about 4 mm, depending on the requirements of the overall printing system. In certain embodiments, the topcoat composition may be applied to the imaging blanket and then cured. The curing may be performed at an elevated temperature, such as a temperature ranging from about 135° C. to about 165° C., such as about 160° C. This elevated temperature is in contrast to room temperature. The curing may occur for a time period of from about 15 minutes to about 5 hours, such as about 1 hour to about 4 hours or from about 2 hours to about 3 hours. In certain embodiments, the curing may occur at about 160° C. for about 4 hours. The topcoat composition may further comprise a catalyst, such as a platinum catalyst, which may serve to reduce the time and/or temperature for curing.

As disclosed herein, the imaging blankets coated with the topcoat composition disclosed herein may demonstrate enhanced imaging capabilities, for example by reducing coating defects on a target image receiving media substrate. In certain embodiments, the imaging blanket as disclosed herein may show improved coating properties in that during printing, the resultant image exhibits reduced coating defects, such as reduced tree-bark defects and other visual imperfections. This enhanced imaging capability may be observed in part because the coated imaging blanket maintains desirable surface roughness and mechanical properties, such as viscoelastic properties. The properties of the topcoat composition coated on the imaging blanket can ensure good and long-lasting print quality.

For example, the topcoat composition on the imaging blanket can conform to the texture of a target substrate, which may have surface peak-to-valley depth somewhat greater than the surface peak-to-valley depth of the imaging blanket. These peaks and valleys that make up the topcoat surface may enhance the static or dynamic surface energy forces that attract the fountain solution to the topcoat surface. This reduces the tendency of the fountain solution to be forced away from the surface by roller nip action. Thus, the surface roughness of the imaging blanket may help to deliver a more uniform layer of printing material to the target substrate, free of defects such as mottle. Sufficient pressure is used to transfer the image from the imaging blanket to the target substrate, wherein pinching the target substrate between the imaging blanket and an impression roller provides this pressure. The topcoat composition should also have desirable mechanical properties, including viscoelasticity, such that the deformation of the topcoat composition caused by the pressure of the impression roller is sufficient to adhere the fountain solution to the target substrate.

Mechanical properties may be evaluated, for example, by dynamic mechanical analysis (DMA), such as a DMA Q800 apparatus commercially-available from TA Instruments. The DMA apparatus applies a sinusoidal stress to a cured topcoat composition while measuring the resulting strain. From the stress/strain data, the complex modulus (G*) may be calculated, as well as the storage modulus (G′), the loss modulus (G″), and the loss tangent (tan δ) were extracted from the complex modulus. Storage modulus is the elastic constituent of a material and can be related to material stiffness (the greater the value, the greater the stiffness). Loss modulus is a measure of the viscous nature of a material and can be related to the material's ability to dissipate energy via molecular motion (the greater the value, the more viscous nature). The tan δ is the ratio of loss modulus to storage modulus (G″/G′). A material having a higher tan δ tends to have a higher viscosity, whereas a material having a lower tan δ tends to have a higher elasticity. In certain embodiments disclosed herein, the topcoat composition may have a tan δ at 25° C. ranging from about 0.08 to about 0.20, such as from about 0.09 to about 0.17 or from about 0.10 to about 0.15, as measured by dynamic mechanical analysis.

In certain exemplary embodiments, the mean surface roughness (Rₐ) of the topcoat composition or the imaging blanket that has been coated with a topcoat composition as disclosed herein may range from about 0.2 μm to about 1 mm, such as from about 0.2 μm to about 1 μm or from about 0.3 μm to about 0.7 μm. Rₐ may be measured by any means known in the art. For example, in certain embodiments, Rₐ may be measured using a stylus-type surface roughness meter, such as SURFCOM 1400A produced by Tokyo Seimitsu Co., Ltd.

Further disclosed herein are processes for variable data lithographic printing using an imaging blanket comprising a topcoat composition as disclosed herein. In certain embodiments, the process comprises applying a fountain solution to an imaging member comprising a topcoat composition as disclosed herein. A latent image is formed by evaporating the fountain solution from selective locations on the imaging member surface to form hydrophobic non-image areas and hydrophilic image areas, which form the latent image. The latent image may be developed by applying an ink composition to the hydrophilic image areas and transferring the developed latent image to a receiving substrate.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein.

While the present teachings have been illustrated with respect to one or more implementations, alterations and/or modifications can be made to the illustrated examples without departing from the spirit and scope of the appended claims. In addition, while a particular feature of the present teachings may have been disclosed with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and the claims, such terms are intended to be inclusive in a manner similar to the term “comprising.” Further, in the discussion and claims herein, the term “about” indicates that the value listed may be somewhat altered, as long as the alteration does not result in nonconformance of the process or structure to the illustrated embodiment. Finally, “exemplary” indicates the description is used as an example, rather than implying that it is an ideal.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompasses by the following claims.

### EXAMPLES

The following Examples are being submitted to further define various species of the present disclosure. These Examples are intended to be illustrative only and are not intended to limit the scope of the present disclosure. Parts and percentages are by weight unless otherwise indicated.

### Example 1

Topcoat formulations having varying percentages (1.1% and 6.6%) of silicon dioxide were prepared and evaluated. To prepare the topcoat formulations, carbon black, silica, and steel beads were placed in a vacuum oven at 80° C. and 22.5″ pressure for 1 hour to dry. A dispersant, n-butyl acetate, and steel beads were added into a high-density polyethylene (HDPE) bottle, shaken, and put on a roll mill for 5 minutes. The oven-dried carbon black was then added to the HDPE bottle, shaken, and put on a roll mill for 1 hour. An inhibitor was added, shaken, and rolled for 10 minutes, and then fluorosilicone SLM50330 was added, shaken, and rolled for 10 minutes. Finally, a crosslinker SLM50336 was added, shaken, and put on a roll mill overnight at about 108 revolutions/min for at least 18 hours. The total rolling time of the dispersion was between 20 to 24 hours.

The following day, before coating, the steel beads were filtered out and the viscosity was measured to ensure a viscosity between about 380 and 420 cP. A catalyst was added to the bottle and put on the roll mill for 5 minutes, and the dispersion was then filtered through a 40 micron fabric filter, de-gassed for 15 minutes, and coated onto a carcass as a topcoat. The topcoat composition was then cured at 160° C. for 4 hours.

Topcoat formulations were prepared having a 1% silicon dioxide content and a 6.5% silicon dioxide content, as shown below in Table 1.

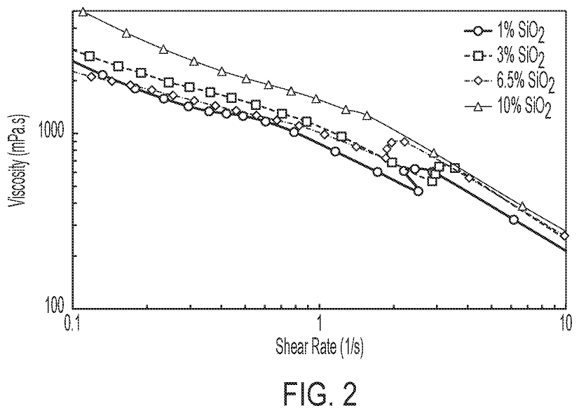

Shear rate was measured as a function of viscosity for four different topcoat formulations containing varying amounts of silicon dioxide (i.e., 1%, 3%, 6.5%, and 10%) without catalyst, as shown below in Table 1 and in FIG. 2.

TABLE 1
Shear rate as a function of viscosity for topcoat formulations

| Topcoat | | Topcoat | | Topcoat | | Topcoat | |
|---|---|---|---|---|---|---|---|
| (1% SiO₂) | | (3% SiO₂) | | (6.5% SiO₂) | | (10% SiO₂) | |
| | Shear | | Shear | | Shear | | Shear |
| Viscosity | Rate | Viscosity | Rate | Viscosity | Rate | Viscosity | Rate |
| (mPa · s) | (l/s) | (mPa · s) | (l/s) | (mPa · s) | (l/s) | (mPa · s) | (l/s) |
| 2160 | 0.132 | 2760 | 0.117 | 2110 | 0.119 | 4950 | 0.11 |
| 1770 | 0.209 | 2420 | 0.153 | 1990 | 0.144 | 3750 | 0.165 |
| 1580 | 0.234 | 2220 | 0.189 | 1890 | 0.171 | 3030 | 0.233 |
| 1430 | 0.294 | 1960 | 0.245 | 1770 | 0.209 | 2590 | 0.31 |
| 1340 | 0.357 | 1840 | 0.297 | 1650 | 0.255 | 2270 | 0.402 |
| 1300 | 0.42 | 1720 | 0.361 | 1540 | 0.311 | 2060 | 0.505 |
| 1260 | 0.49 | 1600 | 0.44 | 1440 | 0.378 | 1900 | 0.622 |
| 1170 | 0.605 | 1460 | 0.552 | 1350 | 0.46 | 1750 | 0.768 |
| 1020 | 0.79 | 1300 | 0.705 | 1270 | 0.556 | 1580 | 0.969 |
| 790 | 1.16 | 1170 | 0.889 | 1190 | 0.673 | 1370 | 1.28 |
| 604 | 1.72 | 961 | 1.23 | 1110 | 0.827 | 1270 | 1.56 |
| 469 | 2.52 | 685 | 1.97 | 987 | 1.05 | 777 | 2.91 |
| 612 | 2.2 | 534 | 2.87 | 841 | 1.41 | 386 | 6.66 |
| 628 | 2.44 | 589 | 2.96 | 724 | 1.86 | | |
| 605 | 2.88 | 648 | 3.06 | 888 | 1.96 | | |
| 323 | 6.15 | 636 | 3.55 | 895 | 2.22 | | |
| | | | | 558 | 4.05 | | |
| | | | | 261 | 9.87 | | |

As shown in Table 1 and FIG. 2, once the solids percentage of silica is at least 6.5%, the S-shaped transition is out of the 2-3 l/s range of shear rate. However, for both 1% and 3% silicon dioxide formulations, there is a pronounced S-shaped curve, exhibiting a negative slope between the high and low viscosity transition. The S-shaped curve is minimized with the 6.5% silicon dioxide formulation and disappears entirely in the 10% silicon dioxide formulation. Notably, upon printing on a media substrate, no tree-bark defect was observed once the silica was at least 6.5% (i.e., for both the 6.5% SiO₂ and 10% SiO₂ formulations).

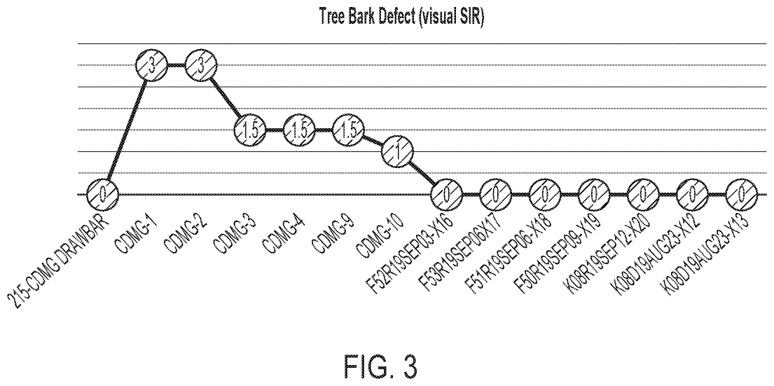

Tree-bark defect was even less visible with dispersion age, as shown in Table 2, below. Tree-bark defects were observed by a visual subjective image rating for 7 different samples of a 6.5% silica dispersion topcoat printed with a DALI engine. Visual subjective image rating of the coating defect for tree bark was reduced to zero (wherein zero indicates there is no visible defect) when a 6.5% SiO₂ topcoat formulation was used, as compared to 1-3 (indicating an increasing amount of visible defect) when a 1% SiO₂ topcoat was used. Note that there was no tree-bark defect observed when a 1% SiO₂ topcoat was coated using a draw bar coating method, due to the low shear rate. See FIG. 3.

TABLE 2
Tree Bark Defect (Visual Subjective Image Rating)

| | Tree Bark | | Tree Bark |
|---|---|---|---|
| | Defect | | Defect |
| Topcoat Sample | (Visual | Topcoat Sample | (Visual |
| (1% SiO₂) | observation) | (6.5% SiO₂) | observation) |
| 1% SiO₂ topcoat | 0 | 6.5% SiO₂ - Sample 1 | 0 |
| with draw bar | | | |
| coating method | | | |
| 1% SiO₂ - Sample 1 | 3 | 6.5% SiO₂ - Sample 2 | 0 |
| 1% SiO₂ - Sample 2 | 3 | 6.5% SiO₂ - Sample 3 | 0 |
| 1% SiO₂ - Sample 3 | 1.5 | 6.5% SiO₂ - Sample 4 | 0 |
| 1% SiO₂ - Sample 4 | 1.5 | 6.5% SiO₂ - Sample 5 | 0 |
| 1% SiO₂ - Sample 5 | 1.5 | 6.5% SiO₂ - Sample 6 | 0 |
| 1% SiO₂ - Sample 6 | 1 | 6.5% SiO₂ - Sample 7 | 0 |

The roughness of the topcoats containing a 1% SiO₂ dispersion and a 6.5% SiO₂ dispersion was measured, including the mean roughness (Rₐ), the number of peak counts greater than about 2 μm, and the number of valley counts greater than about 2 μm. There was no significant difference measured between the roughness in the 1% SiO₂ samples and the 6.5% SiO₂ samples tested, as shown below in Table 3.

TABLE 3
Surface roughness of 1% and 6.5% SiO₂ dispersion topcoats

| Topcoat | Peak | Valley | Mean | Topcoat | Peak | Valley | Mean |
|---|---|---|---|---|---|---|---|
| Sample | Count > | Count > | roughness | Sample | Count > | Count > | roughness |
| (1% SiO₂) | 2 μm | 2 μm | (Rₐ, μm) | (6.5% SiO₂) | 2 μm | 2 μm | (Rₐ, μm) |
| 1% SiO₂ | 5 | — | — | 6.5% SiO₂ - | 9 | 1 | 0.291 |
| topcoat | | | | Sample 1 | | | |
| with draw | | | | | | | |
| bar | | | | | | | |
| coating | | | | | | | |
| method | | | | | | | |
| 1% SiO₂ - | 21 | 6 | 0.53 | 6.5% SiO₂ - | 6 | 0 | 0.279 |
| Sample 1 | | | | Sample 2 | | | |
| 1% SiO₂ - | 48 | 3 | 0.51 | 6.5% SiO₂ - | 15 | 1.5 | 0.311 |
| Sample 2 | | | | Sample 3 | | | |
| 1% SiO₂ - | 33 | 9 | 0.65 | 6.5% SiO₂ - | 21 | 21 | 0.422 |
| Sample 3 | | | | Sample 4 | | | |
| 1% SiO₂ - | 132 | 102 | 0.908 | 6.5% SiO₂ - | 0 | 1 | 0.259 |
| Sample 4 | | | | Sample 5 | | | |
| 1% SiO₂ - | 0 | 0 | 0.408 | 6.5% SiO₂ - | 10 | 3 | 0.519 |
| Sample 5 | | | | Sample 6 | | | |
| 1% SiO₂ - | 25 | 12 | 0.549 | 6.5% SiO₂ - | 12 | 10 | 0.529 |
| Sample 6 | | | | Sample 7 | | | |

It was further noted that there was no change in mechanical property (e.g., viscoelasticity) of the resultant topcoat when a 6.5% SiO₂ dispersion topcoat was used as compared to a 1% SiO₂ dispersion topcoat. In this regard, Tan Delta at 25° C. was measured by Dynamic Mechanical Analysis (DMA). DMA is a technique known in the art wherein a deformation stress is applied to a sample topcoat in a cyclic manner, allowing the topcoat material being analyzed time to respond to stress and/or other values being tested. The DMA measures the damping of the material as the tan delta, a measure of the samples elastic behavior. Tan delta is measure of the energy dissipation of the material. The tan delta of the samples is shown below in Table 4.

TABLE 4
Tan Delta at 25° C. measured by DMA

| Topcoat Sample | Tan | Topcoat Sample | Tan |
|---|---|---|---|
| (1% SiO₂) | Delta | (6.5% SiO₂) | Delta |
| 1% SiO₂ topcoat | 0.19 | 6.5% SiO₂ - Sample 1 | 0.098 |
| with draw bar | | | |
| coating method | | | |
| 1% SiO₂ - Sample 1 | 0.091 | 6.5% SiO₂ - Sample 2 | 0.101 |
| 1% SiO₂ - Sample 2 | 0.138 | 6.5% SiO₂ - Sample 3 | 0.104 |
| 1% SiO₂ - Sample 3 | 0.126 | 6.5% SiO₂ - Sample 4 | 0.101 |
| 1% SiO₂ - Sample 4 | 0.167 | 6.5% SiO₂ - Sample 5 | 0.139 |
| 1% SiO₂ - Sample 5 | 0.096 | 6.5% SiO₂ - Sample 6 | 0.135 |
| 1% SiO₂ - Sample 6 | 0.113 | 6.5% SiO₂ - Sample 7 | 0.148 |

Additionally, the image quality of the images printed using a 6.5% SiO₂ topcoat on the image blanket was comparable to the image quality of images printed using a 1% SiO₂ topcoat, as shown below in Table 5. An ink roll temperature of 67° C. was used for all runs.

TABLE 5
Print quality observations of 6.5% SiO₂ topcoat

| Description | | | | | | | | |
|---|---|---|---|---|---|---|---|---|
| Topcoat | No coating | 1% | 6.5% | 6.5% | 6.5% | 6.5% | 6.5% | 6.5% |
| formulation | | SiO₂ | SiO₂ | SiO₂ | SiO₂ | SiO₂ | SiO₂ | SiO₂ |
| | | | | | (aged) | | | |
| Carcass/ | Trelleborg | Flint/ | Fling/ | Fling/ | Fling/ | KBRT/ | KBRT/ | KBRT/ |
| coating method | | Ring | Ring | Ring | Ring | Ring | Dip | Dip |
| D4 flow g/min | 1.2 | 1.1 | 1 | 1 | 1.05 | 1.1 | 1.1 | 1.1 |
| xRite - optical | 1.59 | 1.52 | 1.5 | 1.51 | 1.47 | 1.52 | 1.36 | 1.39 |
| density (100% | | | | | | | | |
| DAC) | | | | | | | | |
| xRite - | 0.07 | 0.05 | 0.04 | 0.02 | 0.07 | 0.09 | 0.05 | 0.04 |
| Background | | | | | | | | |
| (dL* = blank-Bg) | | | | | | | | |
| IQAF - | n/a | n/a | 1.041 | 1.104 | 1.24 | 1.11 | 1.08 | 0.98 |
| Background | | | | | | | | |
| graininess | | | | | | | | |
| IQAF - Solid | n/a | 14.59 | 15.03 | 13.35 | 16 | 14.08 | 17.63 | 14.26 |
| Mottle (NMF) | | | | | | | | |
| IQAF - Peak | 26.6/0.30 | 23.32/0.32 | 23.1/0.47 | 22.9/0.45 | 25.2/0.39 | 23.9/0.35 | 24.7/0.61 | 25/0.40 |
| Mottle | | | | | | | | |
| (NMF/Density) | | | | | | | | |
| IQAF - Solid | n/a | 1.411 | 1.567 | 1.378 | 1.695 | 1.46 | 2.05 | 1.61 |
| VNHF (100% | | | | | | | | |
| DAC) | | | | | | | | |
| IQAF - | 77 | 77 | 80 | 76 | 76 | 82 | 79.39 | 83 |
| Macrouniformity | | | | | | | | |
| DAC (20% HT) | | | | | | | | |
| IQAF Raggedness | 1.16 | 1.09 | 0.967 | 0.992 | — | — | — | — |
| (P-H 203 um, | | | | | | | | |
| Target 6) | | | | | | | | |
| IQAF - Line | 0.108 | 0.107 | 0.105 | 0.104 | 0.104 | 0.104 | 0.103 | 0.099 |
| width (P-H 84 um, | | | | | | | | |
| Target 11) | | | | | | | | |
| IQAF - Line | 0.381 | 0.37 | 0.364 | 0.363 | 0.364 | 0.361 | 0.363 | 0.363 |
| width (P-H | | | | | | | | |
| 353 um, Target 1) | | | | | | | | |

Finally, the degree of fluorosilicone crosslinking was measured by fluorosilicone extractable signal from NMR, showing that there was no significant change in crosslinking between a 6.5% SiO₂ topcoat and a 1% SiO₂ topcoat. The degree of crosslinking for both the 6.5% SiO₂ topcoat and the 1% SiO₂ topcoat ranged from about 45-55%, such as from about 48% to about 51%.

The results provided in the Example were obtained from scaled-up dispersions and were demonstrated in a number of actual print tests.

What is claimed is:

1. A topcoat composition for a variable data lithography imaging blanket comprising:
at least one fluorosilicone;
at least one infrared-absorbing filler; and
silicon dioxide present in an amount ranging from greater than about 5% to about 10%, based on a total weight of the topcoat composition,
wherein when the topcoat composition has a shear rate between about 2 s⁻¹ to about 3 s⁻¹, the topcoat composition has a viscosity ranging from about 1500 mPa/s to about 500 mPa/s and the shear rate does not decrease as the viscosity increases or decreases.

2. The topcoat composition of claim 1, wherein the silicon dioxide is present in an amount ranging from about 6% to about 7%, based on a total weight of the topcoat composition.

3. The topcoat composition of claim 1, wherein the silicon dioxide is present in the topcoat composition in an amount ranging from about 6.5% to about 6.6%, based on a total weight of the topcoat composition.

4. The topcoat composition of claim 1, wherein the at least one infrared-absorbing filler is carbon black.

5. The topcoat composition of claim 1, wherein the at least one infrared-absorbing filler is present in the topcoat composition in an amount ranging from about 5% to about 35% by weight, based on the total weight of the topcoat composition.

6. The topcoat composition of claim 1, wherein the at least one fluorosilicone is chosen from vinyl-terminated trifluoropropyl methylsiloxane polymer.

7. The topcoat composition of claim 1, wherein the at least one fluorosilicone is present in the topcoat composition in an amount ranging from about 40% to about 80% by weight, based on the total weight of the topcoat composition.

8. The topcoat composition of claim 1, further comprising at least one dispersant is polyoxyalkylene amine derivative.

9. The topcoat composition of claim 1, further comprising at least one crosslinking agent is methyl hydrosiloxane-trifluoropropylmethyl siloxane.

10. The topcoat composition of claim 1, further comprising at least one catalyst.

11. The topcoat composition of claim 10, wherein the at least one catalyst is a platinum catalyst.

12. An imaging blanket for variable data lithography comprising:
a substrate; and
a topcoat composition according to claim 1.

13. The imaging blanket of claim 12, wherein the substrate comprises at least one material selected from the group consisting of metals, polyimides, plastic composites, and woven fabrics.

14. The imaging blanket of claim 12, wherein the topcoat composition has a thickness ranging from about 0.5 μm to about 4 mm.

15. The imaging blanket of claim 12, wherein the topcoat composition is cured to the substrate at a temperature ranging from about 135° C. to about 165° C. for a time period ranging from about 15 minutes to about 5 hours.

16. The imaging blanket of claim 12, wherein the topcoat composition has a mean roughness Rₐ ranging from about 0.2 μm to about 1.0 μm.

17. The imaging blanket of claim 12, wherein the topcoat composition has a tangent of delta (tan δ) at 25° C. ranging from about 0.08 to about 0.20 as measured by dynamic mechanical analysis.

18. The imaging blanket of claim 12, wherein the topcoat composition has a degree of crosslinking ranging from about 45% to about 55%.

19. A method of making a topcoat composition for a variable data lithography imaging blanket, the method comprising:
mixing in a solvent a dispersant, beads, an infrared-absorbing filler, silicon dioxide in an amount ranging from greater than about 5% to about 10% by weight based on a total weight of the topcoat composition, an inhibitor, a fluorosilicone, and a crosslinking agent to create a mixture;
rolling the mixture;
filtering the mixture to remove the beads;
adding a catalyst to the mixture; and
filtering the dispersant to create a topcoat composition,
wherein when the topcoat composition has a shear rate between about 2 s⁻¹ to about 3 s⁻¹, the topcoat composition has a viscosity ranging from about 1500 mPa/s to about 500 mPa/s and the shear rate does not decrease as the viscosity increases or decreases.

20. A method of reducing coating defects on a media coated using an imaging member for variable data lithography, the method comprising:
applying a fountain solution to an imaging member comprising a cured topcoat composition;
forming a latent image by evaporating the fountain solution from selective locations on the cured topcoat composition to form hydrophobic non-image areas and hydrophilic image areas;
developing the latent image by applying an ink composition to the hydrophilic image areas; and
transferring the developed latent image to a receiving substrate,
wherein the topcoat composition comprises at least one fluorosilicone, at least one infrared-absorbing filler, and silicon dioxide present in an amount ranging from greater than about 5% to about 10%, based on a total weight of the topcoat composition, and
wherein before curing, when the topcoat composition has a shear rate between about 2 s⁻¹ to about 3 s⁻¹, the topcoat composition has a viscosity ranging from about 1500 mPa/s to about 500 mPa/s and the shear rate does not decrease as the viscosity increases or decreases.
